(19) United States
(12) Patent Application Publication
(10) Pub. No.: US 2010/0118739 A1
(43) Pub. Date: May 13, 2010

(54) Method and Apparatus for the Determination of Multiple Spanning Trees

(76) Inventors: Giovanni Fiaschi, Pisa (IT); Riccardo Martinotti, Pisa (IT); Barbara Ghiglino, Pisa (IT)

Correspondence Address: POTOMAC PATENT GROUP PLLC, P. O. BOX 270, FREDERICKSBURG, VA, 22404, US

(21) Appl. No.: 12/596,436

(22) PCT Filed: Apr. 19, 2007
(86) PCT No.: PCT/EP2007/053813

§ 371 Date: Jan. 25, 2010

(51) Int. Cl. H04L 12/28

(52) U.S. Cl. 370/256

(57) ABSTRACT

A method of, and apparatus for, determining multiple spanning trees over a computer network, each spanning tree providing a particular arrangement of communication links between nodes of the computer network, and the method comprising increasing a cost associated with using a particular communications link if said communications link is included in a previously determined spanning tree.

### FIELD OF INVENTION

The present invention relates generally to computer networks.

### BACKGROUND

Computer networks enable the sharing and exchange of information and/or resources. A computer network typically comprises a plurality of computer entities (for example workstations, servers, printers and data storage), which are interconnected by means of one or more communications links. A computer entity is able to transmit or receive data over a communications link. A common type of computer network is a so-called Local Area Network (LAN) in which various computer entities are connected over a particular locality (e.g. within a building or a group of buildings). So called Virtual LANs (VLANs) may be formed using intermediate devices, such as Ethernet switches. Typically the intermediate devices comprise a data processor and a plurality of ports which enable the segmentation of the overall network of computer entities. The switching function comprises receiving data at an input port and transferring that data to an output port. The computer entities are connected to respective intermediate devices and the intermediate devices are connected by way of physical communications links

By configuring the intermediate devices appropriately the various VLANs can be created. Such networks are more particularly known as Virtual Bridged Local Area Networks. It will be appreciated that a single intermediate device may provide a physical connection for members of different VLANs. The VLANs may be arranged in accordance with the Multiple Spanning Tree Protocol in IEEE 802.1Q (which is a standard defining various aspects of VLANs). In such an arrangement each VLAN is determined by a spanning tree instance.

Advantageously use of a spanning tree topology avoids infinite cycling of data frames, which would overwhelm the network. Thus VLANs, which enable multiple spanning tree topologies to be spread simultaneously over the physical network, result in the physical links between individual networks being spread over all of the available physical links and so realising a high resource usage.

However the improvement in network operability introduced by the MSTP comes at the price of an added configuration burden for the network administrator, that is the need to define different active spanning trees that can optimally allocate traffic. We have realised that it would be desirable to define automatically a plurality of spanning trees and consequently derive parameters for the configuration of the standard MSTP in such a way that the spanning tree instances can be implemented with minimum manual intervention. The network administrator needs only then associate the VLANs to the automatically generated MST instances.

### SUMMARY OF THE INVENTION

According to a first aspect of the invention there is provided a method of determining multiple spanning trees over a computer network, each spanning tree providing a particular arrangement of communication links between the nodes of the computer network, and the method comprising increasing a cost associated with using a particular communications link if said communications link is included in a previously determined spanning tree.

In a highly preferred embodiment of the invention there is provided a method to define automatically a set of multiple spanning tree instances to allow automatic re-routing of traffic in the presence of a fault and to allow good traffic distribution over all the available resources of the network. The method is practical in the sense that it comprises a computationally simple algorithm and does not offer a mathematically optimal solution.

According to a second aspect of the invention there is provided apparatus for determining multiple spanning tree instances over a computer network, each spanning tree providing a particular arrangement of communication links between the nodes of the computer network, and the apparatus being configured to increase a cost associated with using a particular communications link if said communications link is included in a previously determined spanning tree.

### BRIEF DESCRIPTION OF THE DRAWINGS

Various embodiments of the invention will now be described, by way of example only, with reference to the accompanying drawings in which:

FIG. 1 is a schematic representation of a network topology comprising Local Area Networks (LANs) and bridging equipment between the LANs,

FIG. 2 is a schematic representation of a first determined spanning tree configuration which represents a first Virtual Local Area Network (VLAN), and

FIG. 3 is a schematic representation of a second determined spanning tree configuration which represents a second VLAN.

### DESCRIPTION OF VARIOUS EXEMPLARY EMBODIMENTS OF THE INVENTION

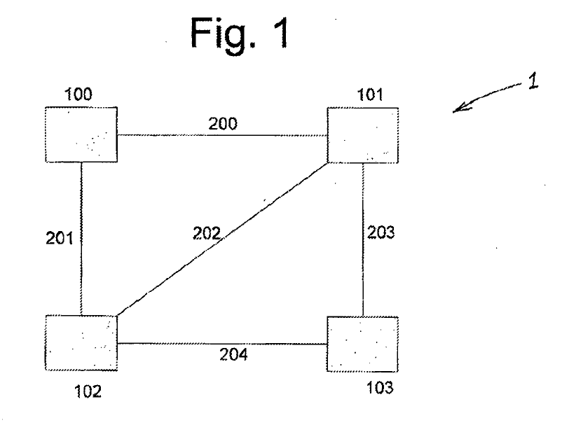

With reference to FIG. 1 there is shown a network comprising a plurality of Local Area Networks (LANs) 200, 201, 202, 203 and 204, which connected by way of four Ethernet bridges 100, 101, 102 and 103. The LANs provide communications links between the Ethernet bridges. Each of the Ethernet bridges has connected thereto one or more computer entities (not illustrated). It is desired to determine a plurality of Virtual Bridged Local Area Networks over the network 1 by way of an initial set-up procedure. It will be appreciated that at least some of the computer entities connected to different Ethernet bridges will be members of the same VLAN.

The description of the procedure which follows is in the form of high level steps including initialisation (Init), iteration (Iteration) and termination (Term) phases.

Step 1 (Init) Initially, the physical topology is defined, with bridges and the LANs connecting the bridges. The LANs are attributed a cost that should reflect the desired LAN utilisation. Cost assignment could be related with the guidelines provided by the relevant IEEE standard, where high capacity LANs have lower costs to encourage their usage. Cost assignment is however an administrative matter and may be achieved on numerous different bases. However a suggested formula is c=k₁/bᵢ, where the cost cᵢ of the i-th LAN is given by an appropriate constant k₁ divided by the LAN bandwidth capacity bᵢ.

Step 2 (Init) Then, a known minimal cost spanning tree algorithm (such as Prim's or Kruskal's algorithm) is run to find a first spanning tree. More sophisticated algorithms can be used to find Minimum Diameter Spanning Trees (MDST) if a higher computational complexity is acceptable. Once the algorithm is chosen, the spanning tree depends on the administrative costs assigned in Step 1. This spanning tree has a total cost that is a function of the sum of the costs of the LANs, assigned in Step 1.

Step 3 (Iteration) The cost of each LAN is replaced with a value that is a function of both its initial cost and the number of found spanning trees that include that LAN. This function should still encourage the usage of high capacity LANs, and at the same time favour the LANs that are covered by the least number of spanning trees. This will allow an even number of spanning trees to be spread over the entire topology. The details of the costs function can be again an administrative matter and may vary according to the policy of traffic allocation. However, an example formula is suggested below. Reasonable functions should be monotonic, in that they always increase or leave unchanged the costs of the LANs: if a LAN was used by some spanning tree in the previous iteration its cost increases, otherwise it remains unchanged.

Step 4 (Iteration) The same minimal cost spanning tree algorithm as used in Step 2 is run on the topology with the new costs computed in Step 3. At the j-th iteration the (j+1)-th spanning tree is found (as the first is the result of Step 2 during init phase). This spanning tree has a total cost that is function of the costs computed in Step 3. The monotonic property of the cost function of Step 3 implies that also the total cost of subsequent spanning trees increases progressively: the cost of the (j+1)-th spanning tree is higher than the cost of the j-th spanning tree.

Step 5 (Term) If the cost of the (j+1)-th spanning tree is “much higher” than the cost of j-th one, it means that the last spanning tree is using: either (i) low capacity LANs or (ii) LANs that are already loaded with several spanning trees therefore its contribution would not bring meaningful improvements to the traffic load, the iteration can be terminated and the last spanning tree discarded. As noted above, “much higher” is a condition to be defined according to the needs of a specific situation. Terminating earlier (a low value for “much higher”) will produce a lower number of spanning trees, that means lower configuration load and coarser load balancing. On the contrary, a “very much higher” cost will lead to a higher number of spanning trees, with higher configuration complexity, but the opportunity for a finer traffic distribution. According to the MSTP standard, the procedure must terminate in any case when 64 spanning trees are produced.

After the completion of the above procedure, a collection of spanning trees is produced with enough routing diversity/choices to allow a convenient traffic distribution/balancing of the VLANs over the network topology. The above procedure defines trees, in terms of
all the bridges of the physical topology and
a subset of the LANs of the physical topology.

(Appropriate parameters for each MSTI (MST protocol instance) to be used by the IEEE standard protocols must be derived.)

The network operator is then able to manually assign each spanning tree instance to form a VLAN.

An example of a formula to appropriately increase LAN costs at each iteration as needed in Step 3 is the following:

cᵢⱼ=(max_costᵢ−min_costᵢ)·(nᵢⱼ/max_{—}n)^{inst}^{_{—}}^{curv}

where:
cᵢⱼ is the cost of the i-th LAN at the j-th iteration,
max_costᵢ is the maximum cost related to the bandwidth of the i-th LAN,
min_costᵢ is the minimum cost related to the bandwidth of the i-th LAN,
nᵢⱼ is the number of spanning trees using LAN i at iteration j,
max_n is the maximum number of spanning trees (that is 64 for MSTP),
inst_curv is the curvature of the cost curve on nᵤ basis (eg if equal to 1 it's linear).

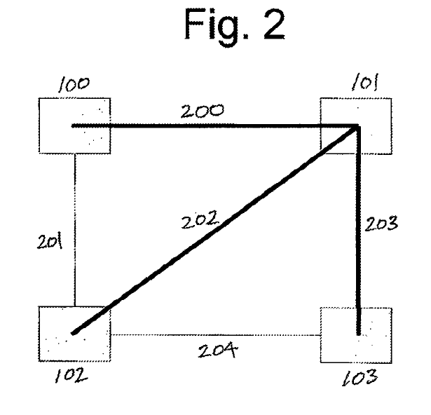

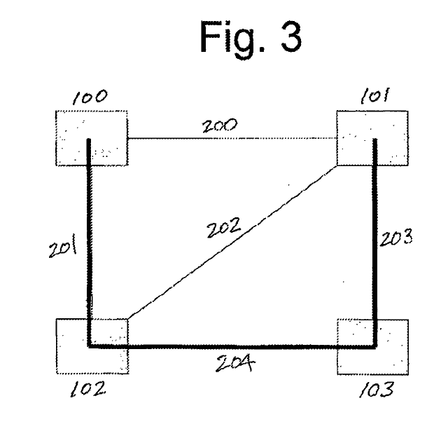

With reference to FIGS. 2 and 3 there are shown two possible VLANs, each of which corresponds to a calculated spanning tree instance.

It will be appreciated that in practice the network administrator will use a data processor to determine the various spanning tree instances. The administrator will have specified to the data processor an indication of what is an acceptable maximum cost so that no further spanning tree instances are to be determined. The administrator would then be able to (remotely) configure each of the Ethernet switches to complement the various VLANs.

1. A method of determining multiple spanning trees over a computer network, each spanning tree providing a particular arrangement of communication links between nodes of the computer network, and the method comprising increasing a cost associated with using a particular communications link if said communications link is included in a previously determined spanning tree.

2. A method as claimed in claim 1 comprising determining the increase of the cost as a function of the number of previously determined spanning trees which include the communications link.

3. A method as claimed in claim 1 in which if the particular communications link is not included in a previously determined spanning tree its cost is unchanged.

4. A method as claimed in claim 1 comprising determining the cost of the particular communications link in accordance with the formula:
cᵢⱼ=(max_costᵢ−min_costᵢ)·(nᵢⱼ/max_{—}n)^{inst}^{_{—}}^{curv}
where:
cᵢⱼ is the cost of the i-th link at the j-th iteration,
max_costᵢ is the maximum cost related to the bandwidth of the i-th link,
min_costᵢ is the minimum cost related to the bandwidth of the i-th link,
nᵢⱼ is the number of spanning trees using link i at iteration j,
max_n is the maximum number of spanning trees,
inst_curv is the curvature of the cost curve on nᵢⱼ basis, wherein a curvature equal to 1 corresponds to a linear cost curve.

5. A method for configuring connections between a plurality of switching devices comprising the method of claim 1.

6. Apparatus for determining multiple spanning tree instances over a computer network, each spanning tree providing a particular arrangement of communication links between nodes of the computer network, and the apparatus being configured to increase a cost associated with using a particular communications link if said communications link is included in a previously determined spanning tree.

7-8. (canceled)
